(19) United States
(12) Patent Application Publication
(10) Pub. No.: US 2015/0296520 A1
(43) Pub. Date: Oct. 15, 2015

(54) Multi-SIM Acquisition Performance Improvement by Priority Modification in Partial Out-of-Service Conditions

(71) Applicant: QUALCOMM Incorporated, San Diego, CA (US)

(72) Inventors: Bhaskara Viswanadham Batchu, Hyderabad (IN); Mihir Pravin Nabar, Mumbai (IN); Ling Hang, San Diego, CA (US); Anand Rajurkar, Hyderabad (IN)

(73) Assignee: QUALCOMM Incorporated, San Diego, CA (US)

(21) Appl. No.: 14/250,483

(22) Filed: Apr. 11, 2014

(51) Int. Cl. H04W 72/04; H04W 72/02

(52) U.S. Cl. CPC H04W 72/0493; H04W 72/02

(57) ABSTRACT

Various embodiments for improving acquisition of services in multi-SIM mobile devices by using modified priorities for radio access technologies (RATs) in partial out-of-service conditions include determining when a first radio access technology (RAT) within a plurality of RATs begins to use a shared resource within the multi-SIM mobile device that is configured to be utilized by the plurality of RATs, determining whether a second RAT within the plurality of RATs was in-service or out of service at the time when the first RAT began using the shared resource, calculating a modified priority value for the second RAT in response to determining that the second RAT was in-service at the time, and determining an order for subsequent scanning for the services by the plurality of RATs based on the calculated modified priority value for the second RAT when the second RAT in-service at the time.

### BACKGROUND

Mobile devices with multiple subscriptions or SIMs (subscriber identification modules) are becoming more widespread due to their versatility in permitting users to connect to multiple networks. For example, a user with a Dual-Subscription, Dual Standby (DSDS) device may connect to a first cellular network with a first SIM module (or card) and/or a second cellular network with a second SIM module. Typically in such multiple SIM devices (referred to herein as “multi-SIM mobile devices”), each SIM module is associated with a different subscription, which may correspond to a different network carrier or type of service.

Different subscriptions supported in a multi-SIM mobile device may utilize different radio access technologies (RATs), which refers to the protocols or communication standards used to connect to a cellular communication network, such as 3G, 4G Long Term Evolution (LTE), Global System for Mobile Communications (GSM), CDMA, and W-CDMA networks. Radio access technologies differ in their protocols for communicating with base stations, multiplexing communications among multiple mobile devices, and encoding data within radio frequency (RF) signals. Consequently, communications by different subscriptions using different RATs typically transmit and receive signals at different times and in different formats. To accommodate these differences in communication protocol, a multi-SIM mobile device may include a SIM storing the user registration and provisioning information for a communication service, dedicated memory for maintaining a communication protocol stack, and a modem for each RAT. For ease of reference, the combination of hardware and data supporting a particular service and its associated radio access technology may be referred to herein as a radio access technology or as an RAT.

In some multi-SIM mobile devices, multiple RATs may be configured to share the same device resource(s), such as a single radio frequency (RF) chain, which may include a radio (which is also referred to herein as a “transceiver”) and one or more antennas. In these scenarios, multi-SIM mobile devices may utilize a resource manager or other software to allocate the shared resource(s) to individual RATs. When one RAT begins using the shared resources, such as when acquiring service with a wide area network, the other RATs supported in the multi-SIM mobile device that must compete for the shared device resources may go out-of-service (OOS) as they are unable to communicate with their respective networks. Resource managers in multi-SIM mobile devices typically select the individual RAT that can use shared resources for a period of time based on priority values that may be predefined based on various factors, such as an importance, ranking, purpose, or preference associated with each RAT.

### SUMMARY

Various embodiments provide methods, devices, and non-transitory processor-readable storage media for improving acquisition of services in a multi-SIM mobile device supporting a plurality of radio access technologies (RATs). Some embodiments may include operations including modifying priorities for each of the plurality of RATs that is determined to have been in good channel conditions prior to one of the plurality of RATs beginning to use a shared resource of the multi-SIM mobile device, and determining based on the modified priorities an order in which the plurality of RATs will perform channel scanning to reacquire service when the shared resource becomes available.

In some embodiments, modifying priorities for each of the plurality of RATs that is determined to have been in good channel conditions prior to one of the plurality of RATs beginning to use a shared resource of the multi-SIM mobile device may include determining when a first radio access technology (RAT) within the plurality of RATs begins using the shared resource of the multi-SIM mobile device that is configured to be shared by the plurality of RATs, determining whether a second RAT within the plurality of RATs was in-service or out of service when the first RAT began using the shared resource, and calculating a modified priority value for the second RAT in response to determining that the second RAT was in-service when the first RAT began using the shared resource.

In some embodiments, determining based on the modified priorities an order in which the plurality of RATs will perform channel scanning to reacquire service when the shared resource becomes available may include determining the order in which the plurality of RATs will perform channel scanning to reacquire service based on default priority values for those RATs determined to have been out of service when the first RAT began using the shared resource and based on the modified priorities for those RATs determined to have been in-service when the first RAT began using the shared resource.

In some embodiments, the method may further include performing RAT channel scanning to reacquire service on the plurality of RATs in the determined order when the shared resource becomes available.

In some embodiments, the method may further include storing data to identify those of the plurality of RATs determined to have been in good channel conditions prior to one of the plurality of RATs beginning to use the shared resource as being in a partial out-of-service condition.

In some embodiments, the method may further include storing channel conditions related to each in the plurality of RATs, and determining whether each of the plurality of RATs was in good channel conditions prior to one of the plurality of RATs beginning to use the shared resource of the multi-SIM mobile device based on the stored channel conditions.

In some embodiments, the shared resource may be a radio frequency (RF) chain and the multi-SIM mobile device may be one of a dual-subscription, dual-standby (DSDS) mobile device or a dual-subscription, dual-active (DSDA) mobile device.

In some embodiments, modifying priorities for each of the plurality of RATs that is determined to have been in good channel conditions prior to one of the plurality of RATs beginning to use a shared resource of the multi-SIM mobile device may include modifying the priorities to be values that are higher than a highest stored default priority.

Various embodiments may include a computing device, which may be a computing device configured with processor-executable instructions to perform operations of the methods described above. Various embodiments include a computing device having means for performing functions of the operations of the methods described above. Various embodiments include non-transitory processor-readable medium on which are stored processor-executable instructions configured to cause a processor of a computing device to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system diagram of a communication system including a multi-SIM mobile device supporting a plurality of subscriptions configured to communicate with two communication networks suitable for use with various embodiments of the disclosure.

FIG. 2 is a diagram illustrating changing service conditions of radio access technologies related to events encountered in a multi-SIM mobile device configured to use a typical technique for scanning for services based on priority.

FIG. 3A is a process flow diagram illustrating a method for a multi-SIM mobile device to determine an order for scanning for services using different radio access technologies based on priorities modified due to partial out-of-service conditions according to various embodiments of the disclosure.

FIG. 3B is a diagram illustrating changing service conditions of radio access technologies related to events encountered at a multi-SIM mobile device configured to determine an order for scanning for services based on priorities modified due to partial out-of-service conditions according to various embodiments of the disclosure.

FIG. 4 is a data structure diagram in the form of a table of example default and modified priorities suitable for use in various embodiments.

FIG. 5 is a process flow diagram illustrating a method for a multi-SIM mobile device to determine scanning priority orders for various services using radio access technologies supported by the multi-SIM mobile device based on identified partial out-of-service conditions according to various embodiments of the disclosure.

FIG. 6 is a component block diagram of an example tablet multi-SIM mobile device suitable for use with various embodiments of the disclosure.

FIG. 7 is a component block diagram of a multi-SIM mobile device suitable for use with various embodiments of the disclosure.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “mobile device” or “mobile computing device” are used herein to refer to any one or all of cellular telephones, smart-phones (e.g., iPhone), web-pads, tablet computers, Internet enabled cellular telephones, WiFi enabled electronic devices, personal data assistants (PDA's), laptop computers, personal computers, and similar electronic computing devices equipped with at least a processor, a shared RF resource, and circuitry for supporting two or more radio access technologies. Mobile devices include DSDS devices configured with a network transceiver configured to establish a wireless connection with a cellular telephone or data network (e.g., an LTE, 3G or 4G wireless wide area network). The term “multi-SIM mobile device” is used herein to refer to any mobile device configured to use more than one SIM module (or subscription), such as DSDS mobile device.

In a typical DSDS multi-SIM mobile device, the various RATs associated with the device's supported subscriptions share and RF resource, and thus may be in an idle mode when not actively communicating (i.e., transmitting or receiving wireless signals with its respective network). Once a service/RAT has registered with its respective network, it may periodically request use of the shared resources (particularly a shared RF chain) from the multi-SIM mobile device for conducting network operations, such as listening for and responding to network pages, sending or receiving data, and making or receiving voice calls, by signaling a resource manager routine. For example, the RATs may each periodically request use of the shared RF chain in order to perform scans and acquire a pilot signal. The resource manager may use a predefined priority value and/or other data to sort or otherwise order the various requests for resource usage by the different RATs. By default, RATs supported by a multi-SIM mobile device may be associated with predefined priority values, codes, or labels (referred to herein as “default priorities” or “default priority values”) that may be based on the characteristics, associated standard, use, or preference information associated with the RATs. In general, the resource manager may grant access to shared device resources to RATs with higher default priorities before RATs with lower default priorities.

When one RAT (a “first RAT”) among a plurality of radio access technologies (RATs) sharing device resources begins using the shared resources to participate in a call (referred to herein as a “switchover event”), the rest in the plurality of RATs may necessarily go out-of-service for the duration of that call. For example, in a DSDS mobile device, only one RAT may be able to use a shared RF chain to make a voice call at a time.

When the first RAT is using the shared device resources, the other out-of-service RATs may not be in the same posture or condition, because some of the out-of-service RATs may have been out-of-service prior to the first RAT obtaining the shared resources. For example, a second RAT may not have had service or a connection to its respective network due to poor channel conditions (i.e., non-existent or weak signal strength) or expiration of idle/access/traffic fade timers at the time the first RAT took over the shared resources. Other RATs that are out-of-service because of a switchover event may have been in good service conditions prior to the switchover event. For example, a third RAT may have had full service with its network before a call began on the first RAT, but because the first RAT held the shared RF chain for a long time, the third RAT may have experienced starvation and gone out-of-service. As another example, after a traffic call release, the first RAT may go out-of-service before the multi-SIM mobile device performs operations to re-acquire service on the same channel for the first RAT.

RATs with no service prior to one RAT obtaining the shared resources for a call (i.e., a switchover event) may be referred to throughout this disclosure as being in an “actual out-of-service” condition (or an “actual OOS” condition) in order to distinguish them from RATs that are out of service only due to the use of the shared resources by the first RAT (i.e., they had service prior to the switchover event), which may be referred to herein as being in a “partial out-of-service” condition (or a “partial OOS” condition).

In scanning operations that use typical priority ordering schemes, RATs in partial out-of-service conditions may be prevented from obtaining shared resources or coming back to service in a timely fashion, despite having had good channel conditions prior to a switchover event. For example, a typical multi-SIM mobile device may perform scans (or searches) of all frequency bands associated with higher priority RATs before lower priority RATs, which may lead to starvation and increased acquisition time for the lower priority RATs. This may occur because in typical schemes, RATs with high default priorities may be given importance over RATs with lower default priorities regardless of their respective channel conditions. Consequently, lower priority RATs that had good channel conditions may only return to service after potentially prolonged scanning operations for the higher priority RATs. If the higher priority RATs are experiencing poor or unavailable channel conditions, the delay before the lower priority RATs can acquire service may be long enough to impact the user experience. Thus, in circumstances in which one or more high priority RATs had been out of service due to poor channel conditions but lower priority RATs had been in good channel conditions prior to the switchover event, the user may perceive that the mobile device is unable to acquire service even though the lower priority RATs could immediately do so if permitted timely access to the shared device resources.

As an illustration, consider the following scenario. If a first high data rate RAT has a higher default priority than a second 1x Code Division Multiple Access (CDMA) RAT, when the two RATs try to acquire a shared resource at the same time, the first high data rate RAT may be given the shared resource before the second 1x CDMA RAT. However, if the first high data rate RAT was experiencing an actual OOS condition (e.g., had a non-existence signal strength) at the time of a switchover event, the first high data rate RAT may require a significant period of time (e.g., 10 seconds) to attempt to acquire service (including time required to search all frequencies associated with that RAT before concluding that no service is available) before the second 1x CDMA RAT is permitted to use the shared resources enabling it to acquire service, even though the second 1x CDMA RAT was in very good channel conditions prior to the acquisition operations (i.e., in a partial OOS condition). Thus, without a different priority scheme, the second 1x CDMA RAT in the partial out-of-service condition may encounter needless delays in regaining service. Even though a user may have assigned higher priority to the first high data rate RAT, the user is likely to be frustrated with the delay in receiving any service on his mobile device under such circumstances.

Various embodiments provide devices and methods, including methods implemented in software stored on non-transitory processor-readable media, for improving acquisition of services in a multi-SIM mobile device by using modified priorities for sharing device resources for radio access technologies (RATs) in partial out-of-service conditions. When a switchover event occurs, such as when a first RAT requests a shared resource in order to initiate or receive a voice call, a processor of the multi-SIM mobile device may identify the service conditions of other RATs that are configured to use the shared resource. For example, the multi-SIM mobile device may store and evaluate the state of the channel conditions (e.g., good/full service, limited service, no service, etc.) for a high data rate RAT when a 1x CDMA RAT starts participating in a voice call via a shared RF chain. RATs that were in good channel conditions when a switchover event occurs may be identified as being in a partial out-of-service condition. When the shared resources are freed (e.g., the call by the first RAT ends), a processor of the multi-SIM mobile device may use a higher-than-normal (or modified) priority value for those RATs identified as being in a partial out-of-service condition prior to the switchover event when determining how to allocate the shared resources for performing subsequent scanning operations. This process of assigning a higher than normal priority to partial out-of-service condition RATs may allow those RATs to request and reacquire service before other RATs with higher priority that were actually out-of-service. Because RATs that had good channel conditions prior to the switchover event (i.e. RATs in a partial out-of-service condition) will often rapidly reacquire service by attempting to reestablish the previous connection, partial service can be acquired quickly by the mobile device without significant delaying the scanning process of higher priority RATs that were out of service prior to the switchover event.

As a non-limiting illustration, consider an example in which a DSDS multi-SIM mobile device is configured with a first subscription supported by a first RAT A for the 1x CDMA protocol and a second RAT B for a high data rate protocol, and with a second subscription supported by a third RAT C for the GSM protocol. Consider further that the default priorities of these RATs are RAT B, RAT A, and RAT C (in descending order). Consider further that at a point in time, RAT A and RAT C are in an idle condition but with good channel conditions and RAT B is out-of-service (e.g., experiencing too low or non-existent signal strength). In this situation, if a GSM call is made via RAT C, which constitutes a switchover event, RAT A will go into a partial out-of-service condition because it had good channel conditions before the switchover event. When the GSM voice call on RAT C ends, the RATs may request shared resources from a resource manager for reacquisition of service Implementing various embodiments, the resource manager may enable RAT A to conduct a channel scan to reacquire service before allowing RAT B to do so, even though RAT B has a higher default priority because RAT A was in partial out-of-service condition and RAT B was in an actual out-of-service condition.

In various embodiments, the multi-SIM mobile device may determine orders for scanning for services by using modified priority values for RATs identified as being in partial out-of-service conditions. The multi-SIM mobile device may calculate a modified priority value for each RAT using each RAT's default priority value. The modified priority value for an individual RAT may be a code, value, and/or label that represents an importance, order, or rank that is higher (or more preferred) than that RAT's default priority value. For example, a first RAT with a low default priority value (e.g., 1 out of 20) established by an operating system may be assigned a modified priority value that is significantly higher (e.g., 11 out of 20). A processor of the multi-SIM mobile device may calculate modified priority values such that partially out-of-service RAT with the lowest default priority value may have a modified priority value that is higher than the highest default priority value of any actually out-of-service RAT configured to access the same shared resources. For example, when the highest default priority value in a multi-SIM mobile device is 10, a low default priority RAT that was partially out of service may have a modified priority value of 11. In this way, the multi-SIM mobile device may ensure that a low priority RAT in a partial OOS condition may be given an opportunity to scan for service before any RATs in actual OOS conditions. Consequently, those RATs that may rapidly reacquire service may be given the opportunity to do so before other RATs that may take longer to acquire service.

In situations in which there are multiple RATs in partial OOS conditions, a processor of the multi-SIM mobile device may assign modified priority values for each of the multiple RATs that takes into account their respective priorities. Thus, the modified priority order of multiple RATs in partial OOS conditions may be the same as the order for those same RATs based solely on their default priority values.

In various embodiments, the multi-SIM mobile device may utilize modified priority values to determine the order for scanning operations that are only performed immediately after the conclusion of a switchover event. For example, a first RAT's modified priority value may only be used to order the first RAT above a normally-higher priority second RAT's for scanning operations performed immediately after the end of a voice call and the shared RF chain becomes available. The multi-SIM mobile device may revert to using default priority values for the various RATs in subsequent scanning operations. Thus, the modified priority values may be determined at the time of each switchover event and may be temporary, enabling the mobile device to respond to changes in channel conditions of all of the RATs.

In some embodiments, the multi-SIM mobile device may perform scanning operations for RATs with modified priority values using a last known “good” frequency band first. In other words, the multi-SIM mobile device may store the frequency band that a RAT in a partial out-of-service condition was using prior to a switchover event, and use that stored frequency band in the scanning operations immediately subsequent to the switchover conclusion. So, when any RAT is determined to be in a partial out-of-service condition, the multi-SIM mobile device may be able to simply scan a single channel to reacquire service for that RAT.

Various embodiments differ from other techniques for prioritizing RATs reacquiring service that utilize the number of denials of service to re-prioritize technologies. Further, various embodiments do not re-prioritize RATs based on the channels used (i.e., based on channel identities), but instead use channel conditions prior to a switchover event to modify priorities. In other words, the embodiments may use the characterization, context, or reason for a RAT being out of service in order to determine whether to temporarily modify its priority when determining scanning orders so that only the priority of RATs that were in good service conditions and placed out of service may be modified. The embodiments disclosed herein address techniques for determining scanning orders for RATs immediately after the conclusion of a switchover event, and are not related to managing or otherwise defining periods for sleep and/or wake cycles for device resources or RATs.

Various embodiments may be utilized in any scenarios in which multiple RATs of a multi-SIM mobile device are configured to share resources, such as a RF chain. In particular, the embodiments may be utilized in both Dual-Subscription, Dual-Standby (DSDS) and Dual-Subscription, Dual-Active (DSDA) mobile devices. As an illustration of an application in a DSDA device, the embodiments may be useful when there are three RATs (e.g., 1x CDMA, LTE, and GSM), in which two of the three RATs share a first RF chain and the third RAT has exclusive use of the second RF chain. For example, in the case of a DSDA mobile device in which a 1x CDMA RAT and an LTE RAT share a first RF chain and a GSM RAT uses a dedicated second RF chain, when an incoming voice call occurs on the 1x CDMA RAT, the GSM RAT may not be affected because it has access to the second RF chain; however, the LTE RAT will go out of service when the first RF chain is obtained by the 1x CDMA RAT for the voice call. In such circumstances, various embodiments may be useful for prioritizing the LTE RAT and 1x CDMA RAT for accessing the shared RF chain at the end of the call on the 1x CDMA RAT.

With priorities and scanning orders determined using various embodiments, a multi-SIM mobile device's RATs in partial OOS conditions may be able to reacquire service (e.g., acquire a pilot) many milliseconds or seconds faster than with conventional priority techniques. For example, in an average case, a conventional technique may take approximately 7.3 seconds for a 1x CDMA RAT in a partial OOS condition to reacquire a pilot after a switchover event concludes (e.g., when a GSM voice call ends), whereas an average time using the embodiment methods may only take approximately 300 milliseconds. As another example, in a worst case circumstance, a conventional technique to reacquire a pilot may take approximately 60 seconds for a 1x CDMA RAT in a partial OOS condition to reacquire a pilot after a switchover event concludes, whereas a worst case circumstance using embodiment methods to reacquire a pilot may only take approximately 700 milliseconds.

Thus, by modifying priorities for RATs known to have been in good channel conditions prior to a switchover, the embodiment methods may increase the chance of successfully reacquiring connectivity for partial out-of-service condition RATs with faster acquisition times and reduced RF chain contention, thereby improving the overall mobile device performance. Further, RATs in good channel conditions may be able to return to service before RATs in actual OOS conditions, regardless of their respective default priority values.

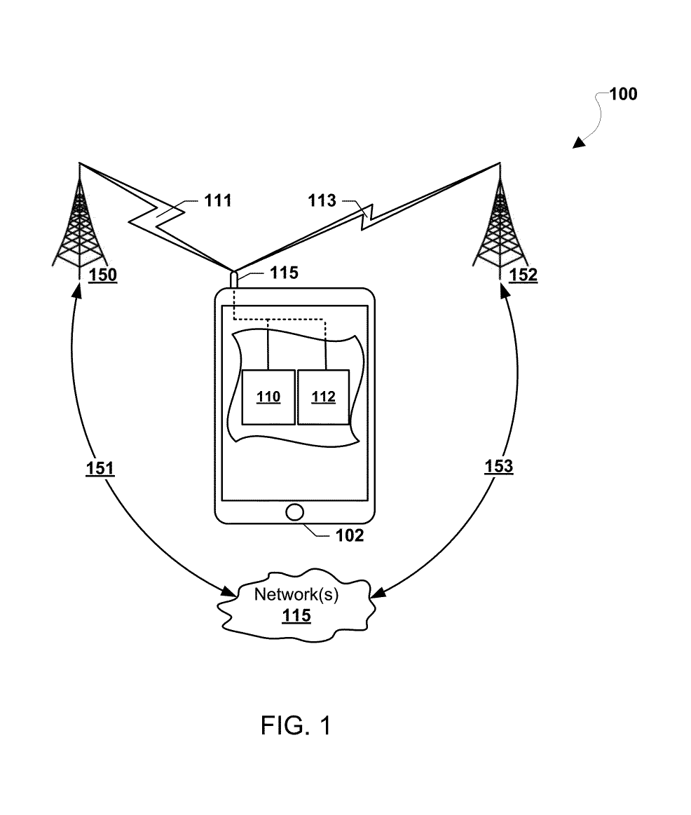

FIG. 1 illustrates a communication system 100 including a multi-SIM mobile device 102 configured to utilize different radio access technologies (RATs) suitable for use with various embodiments of the disclosure. The multi-SIM mobile device 102 may be configured with provisioning information for supporting a first subscription with such information stored on a first SIM module 110, and with provisioning information for supporting a second subscription with such information stored on a second SIM module 112. The first subscription enabled by provisioning information stored in the first SIM module 110 may be associated with a first radio access technology and the second subscription enabled by provisioning information stored in the second SIM module 112 may be associated with a second radio access technology. Various embodiment multi-SIM mobile devices 102 may be configured with RATs compliant with communication standards such as Global System for Mobile Communications (GSM), 4th Generation Long Term Evolution (LTE), CDMA2000 1xEV-DO (or Evolution-Data Only), etc. For example, the first SIM module 110 may be associated with a high data rate (e.g., LTE) signaling standard and the second SIM module 112 may be associated with signaling according to a CDMA2000 1xEV-DO standard. Further, the first and second SIM modules 110, 112 may store provisioning information for connecting to cellular networks that utilize more than one radio access technology. Also, the multi-SIM mobile device 102 may be configured to operate as a Dual-SIM, Dual Stand-by (DSDS) or a Dual-SIM, Dual Active (DSDA) device.

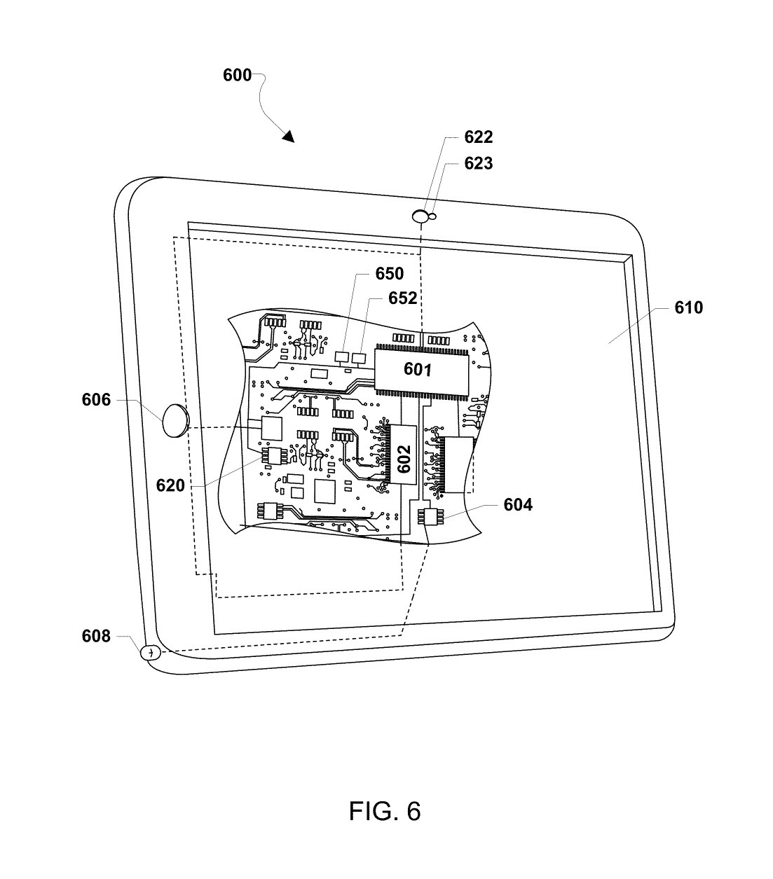

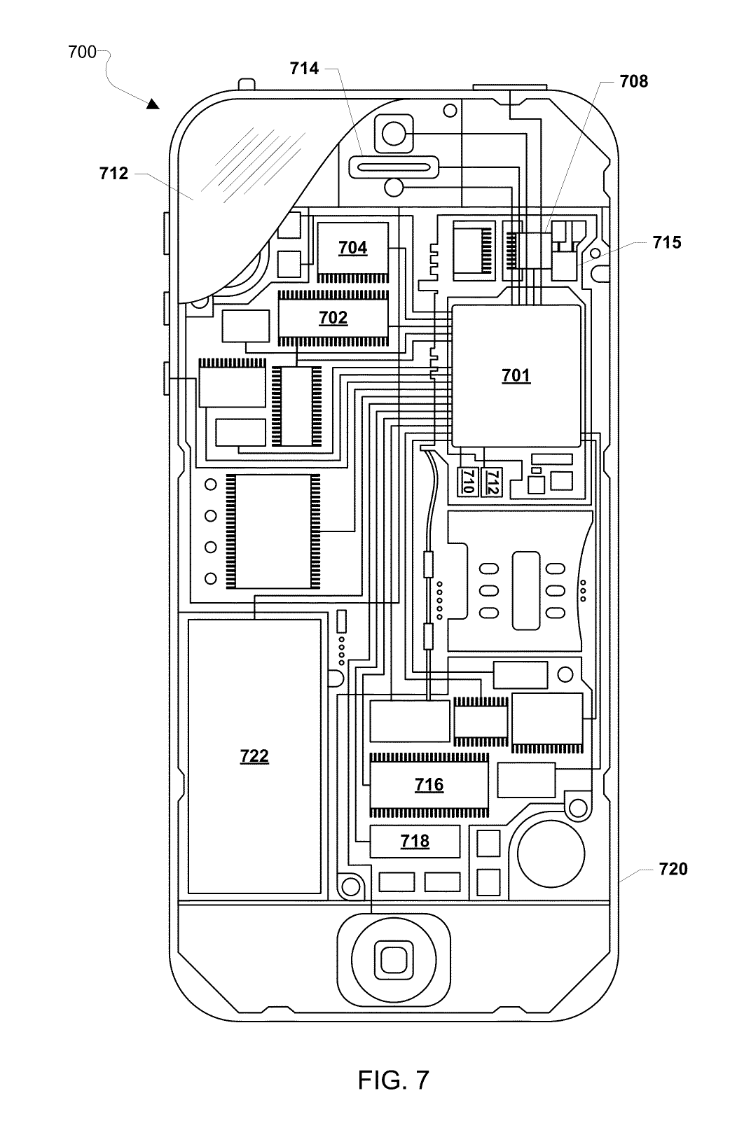

The SIM modules 110, 112 may be coupled to a processor (e.g., 601 and 701 in FIGS. 6 and 7, respectively) and/or a modem that is configured to process data associated with the respective RATs and that is received and/or transmitted via at least one antenna 115. For example, the multi-SIM mobile device 102 may be configured to exchange data with a first access point 150 associated with the first RAT of the first SIM module 110 via a first wireless communication link 111, and to exchange data with a second access point 152 associated with the second RAT of the second SIM module 112 via a second wireless communication link 113. The access points 150, 152 may be connected to wide area network(s) 115 (e.g., the Internet) via their respective communication networks 151, 153.

The wireless communication links 111, 113 between the multi-SIM mobile device 102 and the access points 150, 152 may be of varying signal strength (or energy level) or connection quality based on a variety of factors, such as the distance of the multi-SIM mobile device 102 to the respective access points 150, 152, intervening structures, sources of interference, and competition for access to the network by other mobile devices. In general, the signal strength may indicate the channel conditions associated with the access points 150, 152 and thus the services available for their respective networks. For example, when the signal strength of the first wireless communication link 111 is above a certain threshold, the multi-SIM mobile device 102 may be considered to have full service with the network associated with the first SIM module 110 and the first access point 150. As another example, when the signal strength of the second wireless communication link 113 is below a certain threshold, the multi-SIM mobile device 102 may be considered to have limited or no service (i.e., out-of-service) with the network associated with the second SIM module 112 and the second access point 152.

When the SIM modules 110, 112 are configured to share the same device resources, such as an RF chain and antenna 115, the multi-SIM mobile device 102 may be capable of actively communicating with only one of the access points 150, 152 at a time. For example, a DSDS multi-SIM mobile device may be unable to simultaneously participate in a first voice call using the first RAT of the first SIM module 110 and a second voice call using the second RAT of the second SIM module 112. Thus, when one of the RATs of the SIM modules 110, 112 is engaged in a communication with its respective access point 150, 152 using shared device resources, the other RAT(s) configured to share those device resources may be placed in an out-of-service condition, regardless of the signal strength conditions of the wireless connections used by the other RAT(s). For example, a first RAT associated with the first SIM module 110 may become out-of-service when shared resources are being used by a second RAT associated with the second SIM module 112 to support a voice call. As described above, the first RAT may be determined to be in a partial OOS condition when prior to the second RAT taking over the shared RF chain for the voice call the first RAT had a wireless communication link 111 with strong signal strength.

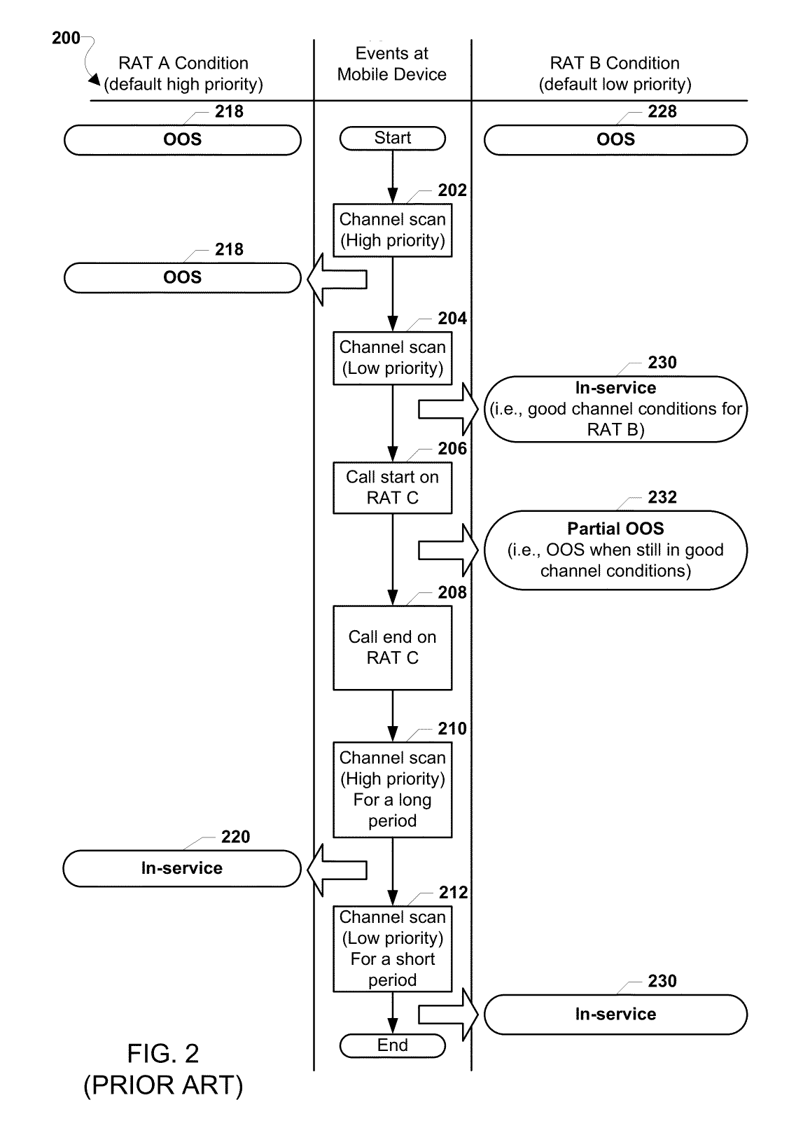

FIG. 2 illustrates how service conditions of radio access technologies may vary based upon events encountered by a multi-SIM mobile device as well as responses of a typical priority scanning technique. Events may be experienced by the multi-SIM mobile device as periodic or scheduled actions, such as regular channel scanning operations performed every certain number of seconds, as well as in response to episodic events, such as an incoming or outgoing telephone call, receipt of an SMS message, etc. For example, events may occur when the multi-SIM mobile device receives user inputs, paging communications, or requests by subscriptions/SIM modules to obtain radio resources and go into traffic (e.g., make an out-going call). The service conditions of the RATs of the multi-SIM mobile device may change in response to the various events indicated by blocks 202-212, such as going into an out-of-service condition (i.e., no connectivity on a RAT due to insufficient signal strength) or a partial out-of-service condition (i.e., no connectivity on a first RAT due to shared resources being obtained by a second RAT).

In the example illustrated in FIG. 2, the multi-SIM mobile device includes a first RAT (referred to as “RAT A” in FIG. 2) having a high default priority value, a second RAT (referred to as “RAT B” in FIG. 2) having a low default priority value, and a third RAT (referred to as “RAT C” in FIG. 2). In the example illustrated in FIG. 2, the multi-SIM mobile device is a DSDS device so only one of the three RATs may use shared resources at a time.

At a starting point, both the RAT A and RAT B may be in an out-of-service (OOS) condition 218, 228. In accordance with its priority, a channel scan for the high priority RAT (i.e., RAT A in this illustration) may occur first in block 202. If it is a result of the channel scan that no satisfactory channel can be identified, the RAT A may remain in an “out-of-service” condition 218. In other words, when the channel scan of the high priority RAT A is unable to find a signal or identified signals are too weak to support communications, RAT A may be considered to have no services available. The condition of RAT B may not change as it is associated with the low default priority value, and thus the channel scan event of block 202 may not relate to RAT B. However, once the channel scan of the higher priority RAT A has completed, the channel scan for the lower priority RAT B may be accomplished in block 204. If the connection is established to a communication network, RAT B may enter the “in-service” condition 230.

In block 206, a call is started on RAT C (which, again, is referred to as a “switchover” event). When this happens, RAT C begins using the shared resources and be in an “in-call” condition (i.e., in a busy traffic state). Because RAT C is using the shared resources to support the call in block 206, the subscription associated with RAT B may lose service, and the status of RAT B may change to a “partial OOS” condition 232 because RAT B had good channel conditions prior to the switchover event of RAT C beginning to use the shared resources in block 206. The change to the “partial OOS” condition 232 may be indicated by a processor of the multi-SIM mobile device setting a parameter, system variable, flag, bit, or other data in response to detecting both that RAT C has begun using the shared resources in block 206 and the previous “in-service” condition 230 for RAT B. Because RAT A did not have service before the switchover event in block 206, RAT A remains out of service. In some embodiments, the processor of multi-SIM mobile device may set a parameter, system variable, flag, bit, or other data indicating that RAT A is actually out of service in response to detecting both the switchover event in block 206 and the previous “out-of-service” condition 218 for RAT A.

When the call being conducted on RAT C ends in block 208 and the shared resources become available for sharing (i.e., upon the conclusion of the switchover event), such as when the call is dropped due to low signal strength for RAT C or one of the participating parties hanging up, the highest priority RAT (i.e., RAT A) performs a channel scan in block 210. In the illustrated example, this time the channel scan by the high priority RAT A results in a connection being established so that the RAT enters the “in-service” condition 220. When services are established on RAT A, a channel scan is conducted on the low priority RAT (i.e., RAT B), which, when successful, results in RAT B entering the “in-service” condition 230 again.

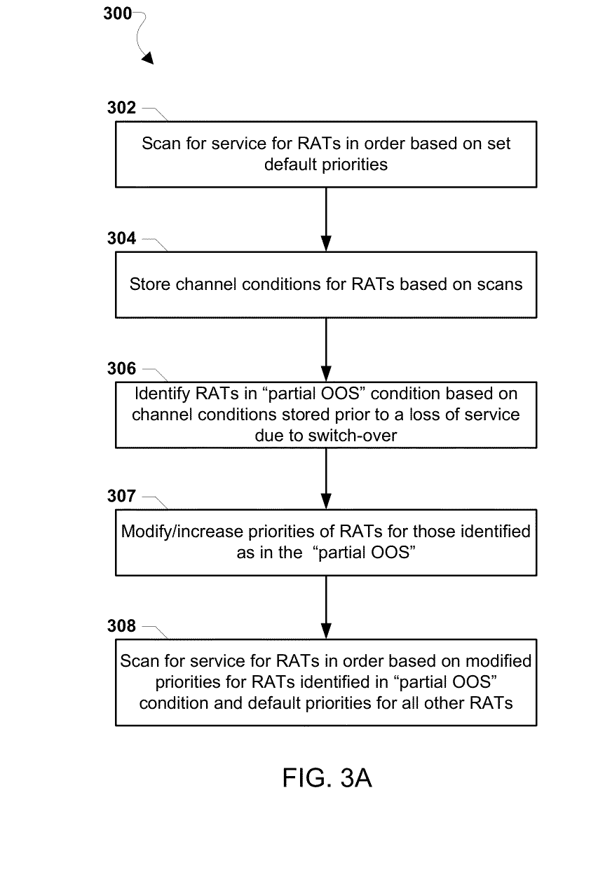

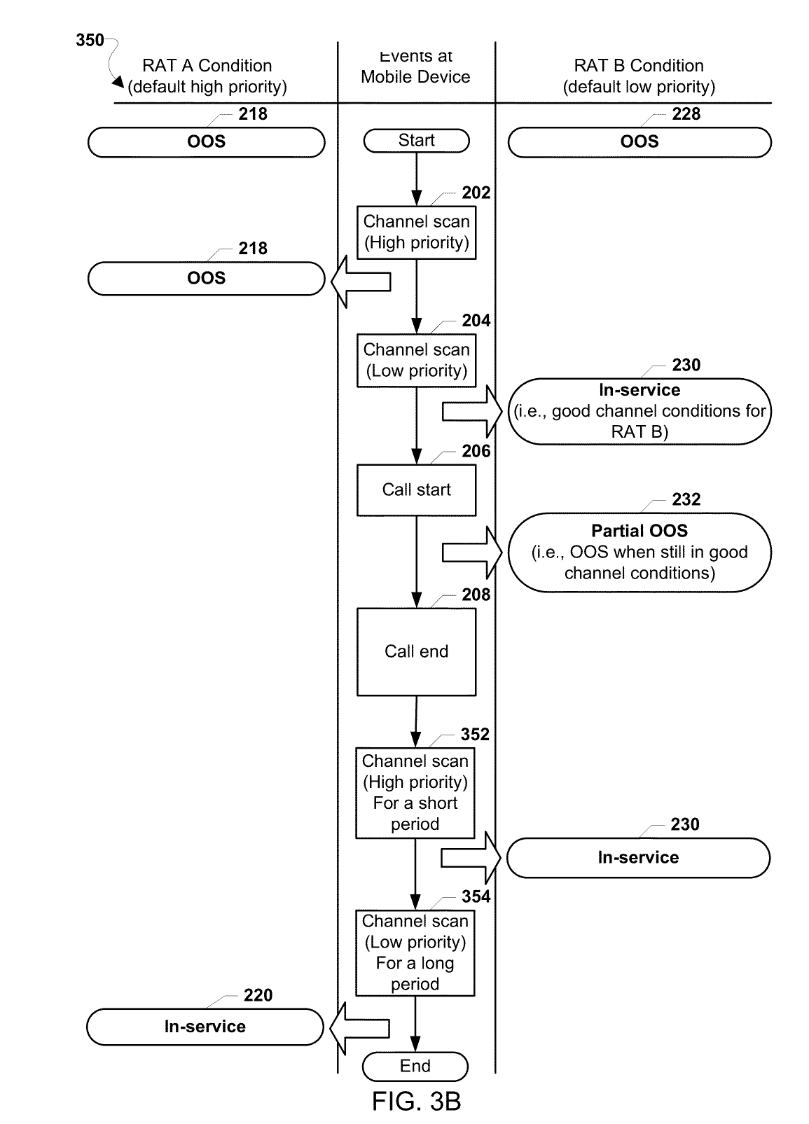

FIG. 3A illustrates a method 300 for a multi-SIM mobile device (e.g., the multi-SIM mobile device 102 in FIG. 1) to identify radio access technologies that are in a partial out-of-service condition based on stored channel conditions occurring prior to a switchover event, and using that information to prioritize the order in which RATs scan for service. As described above, a RAT in a partial out-of-service condition due to a switchover event may quickly recover service when the shared resources are once again available to be used for scanning, as that RAT may still be within good channel conditions after the switchover event. For this reason, the priority of the partial out-of-service RAT may be modified to allow the RAT to conduct the scan and recover service before other RATs that were actually out-of-service, and thus may require longer scanning periods.

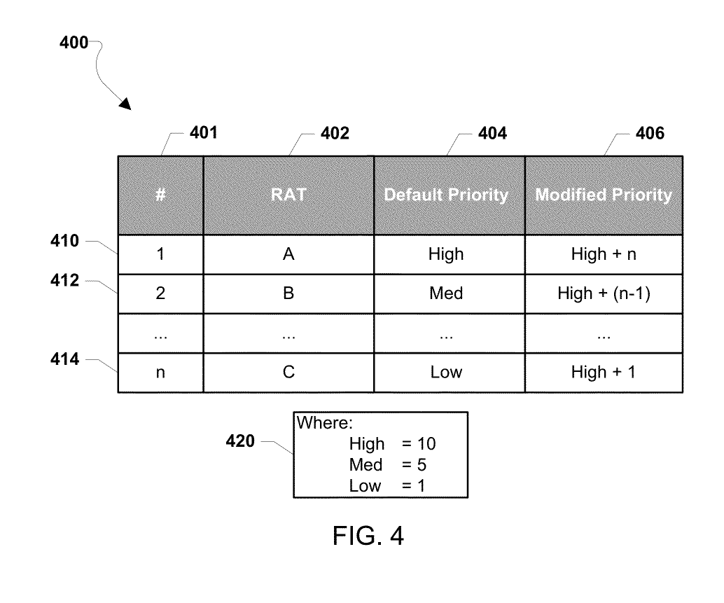

In block 302, the processor of the multi-SIM mobile device may scan for service (or channel conditions) for radio access technologies in an order based on set default priorities. These scanning operations may search for channel conditions for RATs configured to share radio resources (e.g., the same RF chain), and the searches may be from highest priority RAT to lowest priority RAT as defined by default priority values (or data), which may be stored on the multi-SIM mobile device. For example, the multi-SIM mobile device may first conduct the channel scan to determine the availability and signal strength of channels associated with a high priority first RAT and then repeat the process for a low priority second RAT. An example of stored priority data is described in this disclosure (e.g., with reference to FIG. 4).

In block 304, the processor of the multi-SIM mobile device may store channel conditions for the RATs based on the performed channel scans. For example, the multi-SIM mobile device may store signal strength for each supported RAT within a data table such as described in this disclosure (e.g., with reference to FIG. 4). Alternatively, the multi-SIM mobile device may store a code or indicator of the level of service(s) available to each RAT based on the scanning, such as “full” or “limited” or “none”.

In block 306, the processor of the multi-SIM mobile device may identify RATs in a partial out-of-service condition based on the channel conditions stored prior to a loss of service due to a switchover event, such as when a RAT begins using the shared radio resources for an incoming or outgoing call. The multi-SIM mobile device processor may monitor for events as described above, such as incoming call pages and out-going call requests, and when it is determined that a RAT has requested or actually obtained the shared resources (e.g., a shared RF chain), the multi-SIM mobile device processor may iterate through the stored channel conditions and mark those RATs having service immediately before the switchover event as now being in a partial out-of-service condition. In some embodiments, the multi-SIM mobile device may store a list of the current RATs (or their identifiers) in the partial out-of-service condition for use in subsequent scanning operations.

In block 307, the processor of the multi-SIM mobile device may modify (e.g., increase) the priorities of the various RATs based on whether they are identified as being in the partial out-of-service condition, as identified in the operations of block 306. As discussed above, this determination of modified priorities may be based both on the default priority of each RAT and on whether the RAT had good channel conditions prior to using service due to the switchover event. This modification of the RAT priorities may be made at the time that the partial out-of-service condition is identified (e.g., as part of determining their channel conditions prior to the switchover event), or when the shared resources become available for sharing again. Modified priorities may be values pre-calculated and stored by the multi-SIM mobile device. For example, the multi-SIM mobile device may determine a new order for scanning for available services in which a first RAT with a low default priority but a very high modified priority is scanned before a second RAT with a high default priority.

When the current call ends or the shared resources otherwise become available for sharing by the various RATs, the processor of the multi-SIM mobile device may scan for service for RATs in block 308 in an order based on the modified priorities for RATs identified in block 307.

FIG. 3B is a diagram 350 illustrating changing service conditions of radio access technologies related to events encountered in a multi-SIM mobile device (e.g., the multi-SIM mobile device 102 in FIG. 1) implementing an embodiment method for determining modified priorities used for scanning operations. The diagram 350 illustrates how after a switchover ends, a lower priority RAT (i.e., RAT B) may receive access to the shared resources in order to return to service before a higher priority RAT (i.e., RAT A) by the multi-SIM mobile device using the modified priority of RAT B in setting the order for conducting scanning operations. The diagram 350 is similar to the diagram 200 in reference to RAT A, RAT B and RAT C and the sequences of events indicated in blocks 202-208.

In the example illustrated in FIG. 3B, the operations of a channel scan for the high-priority RAT (i.e., RAT A) in block 202 and a channel scan for the low priority RAT (i.e., RAT B) in block 204, followed by RAT C beginning to use the shared resources to start a call in block 206 results in RAT B being identified as in the partial out-of-service condition 232, as described in this disclosure (e.g., with reference to FIG. 2). When the call ends and the shared resources become available for sharing again in block 208 (or sometime before the call ending), the processor of the multi-SIM mobile device may modify/increase the priority for those RATs identified as being in the partial out-of-service condition, which in this example is RAT B. In block 352, the processor of the mobile-SIM mobile device may allocate the shared resources to the highest priority RAT based on the modified priorities to enable that RAT to reacquire service. In this example, RAT B has a modified priority that is greater than RAT A, so RAT B is allowed to use the shared resources first, which results in RAT B entering the in-service condition 230. Because RAT B had good channel conditions prior to the start of the call in block 206, the time to reacquire service in block 352 is relatively short. After RAT B has reacquired service, a channel scan is conducted on the low priority RAT, which in this example is RAT A due to the modified priority of RAT B. In this example, this channel scanning may take a long period of time, which may be due in part to the fact that the RAT was previously out of service, and thus not informed of a good channel on which to start scanning. In this example, this channel scan results in RAT A entering the in-service condition 220.

FIG. 3B illustrates how the order in which the RATs are scanned in blocks 352 and 354 may be opposite to the default order that is described in this disclosure (e.g., with reference to blocks 210 and 212 in FIG. 2). Due to the short period time required to reacquire service on RAT B by starting with a channel that had good channel conditions prior to the switchover event, and doing so before initiating the longer channel scan for RAT A that was previously out of service, the multi-SIM mobile device reacquires service faster in the illustrated circumstances than would be the case following the default process illustrated in this disclosure (e.g., with reference to FIG. 2).

FIG. 4 illustrates an example data structure in the form of a data table 400 for storing RAT default and modified priorities in an embodiment multi-SIM mobile device (e.g., the multi-SIM mobile device 102 in FIG. 1). In general, the table 400 may store data records 410-414 for each radio access technology supported by subscriptions of the multi-SIM mobile device. Each of the data records 410-414 may indicate identifying information of the various RATs, such as default priority values. The table 400 may be implemented in memory (e.g., the memory 702 in FIG. 7, etc.) as a data table within a database, a stored spreadsheet, a collection of application or system variables, or any other data structure capable of being stored, ordered, and/or modified on the multi-SIM mobile device.

The table 400 may include a data column 401 indicating consecutive cardinal numbers (e.g., 1, 2, 3, 4, . . . n, etc.). The numbers in the first data column 401 may be a count of the number of data records within the table 400. For example, the number of a third data record 414 may be ‘n’ where ‘n’ is the total number of data records within the table 400, and thus the total number of RATs supported by the multi-SIM mobile device. The table 400 may also include a data column 402 that indicates the type or identification of the radio access technology associated with each of the data records 410-414. The values in the second data column 402 may indicate a standard, such as 1x, high data rate, LTE, etc., or alternatively may indicate a custom name for a certain technology supported by the multi-SIM mobile device (e.g., A, B, and C in FIG. 4). The table 400 may also include a data column 404 that indicates the default priority value (or level) for each RAT. Such default priorities values may be static values established once when each RAT is detected as supported by the multi-SIM mobile device (e.g., a priority set by a service provider, a manufacturer, or in a standard), or set based on user preferences. In various embodiments, priority values may be number values (e.g., 1, 2, 3, etc.), symbols, or codes that may be pre-associated with priorities, such as qualitative codes (e.g., good, bad, fair, high, medium, low, etc.) or relative codes (e.g., best, worst, etc.).

The table 400 may also include a data column 406 indicating a modified priority value for each RAT of the multi-SIM mobile device. Such modified priority values may be represented as numbers, codes, links to stored data, and/or equations. In some embodiments, the modified priority values may be represented by equations that utilize default priority values, codes, or labels in addition to offset values or codes. For example, a modified priority value stored in a data record for a certain RAT may indicate a modified priority value is the same as the default priority value for another RAT or the default priority value for the another RAT with an offset adder. In various ordering schemes, higher priority values may be associated with higher priorities or inversely lower priorities. For example, a high priority may be associated with a large numeric value (e.g., 10) and a low priority may be associated with a small numeric value (e.g., 1).

In the example illustrated in FIG. 4, the table 400 includes three data records associated with three RATs supported by the multi-SIM mobile device. Accordingly, the variable ‘n’ may be a reference to the number ‘3’. The table 400 may also be associated with legend data 420 that indicates that a ‘High’ priority may be a number value of 10, a ‘Med’ (or medium) priority may be a number value of 5, and a ‘Low’ priority may be a number value of 1. In other words, the exemplary priority scheme may associate high priority RATs with high numeric values and low priority RATs (or labels) with low numeric values.

In the example illustrated in FIG. 4, the first data record 410 is associated with a RAT A that has a default priority ‘High’ and a modified priority “High+n”. For example, the RAT A may have a high default priority value of 10 and a modified priority value that is the high default priority value offset by a value equal to the number of RATs supported in the multi-SIM mobile device (i.e., 10+3=13 modified priority value). In the example illustrated in FIG. 4, the second data record 412 is associated with a RAT B that has a default priority ‘Med’ and a modified priority “High+(n−1)”. In other words, the RAT B may have a medium default priority value of 5 and a modified priority value that is the high default priority value offset by a value equal to the number of RATs supported in the multi-SIM mobile device subtracted by one (i.e., 10+(3−1)=12 modified priority value). In the example illustrated in FIG. 4, the third data record 414 may be associated with a RAT C that has a default priority Tow′ and a modified priority “High+1”. In other words, the RAT C may have a low default priority value of 1 and a modified priority value that is the high default priority value offset by one (i.e., 10+1=11 modified priority value).

In some embodiments, rather than storing a modified priority value, a column may be included in the table 400 indicating whether the RAT is in the partial out-of-service condition, in which case a modified priority may be calculated based on that condition and the default priority in data column 404 at the time that the order in which RATs will be given access to the shared resources is determined.

In some embodiments, rather than storing a modified priority value, a column may be included in the table 400 that stores a multiplier value based on whether the RAT is in the partial out-of-service condition, such a 1 when the RAT was actually out of service before the switchover event and a 10 when the RAT was in service with good channel conditions. In such embodiments, the modified priority for each RAT may be calculated by multiplying the default priority in data column 404 by the stored multiplier, and this simple calculation may be made at the time that the order in which RATs will be given access to the shared resources is determined.

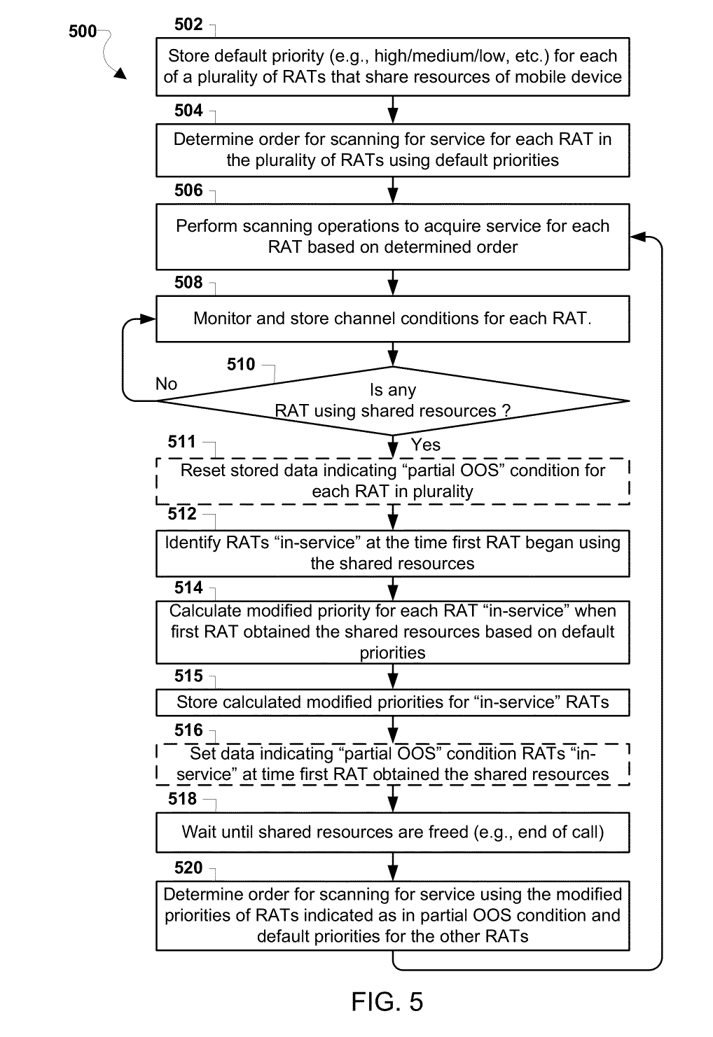

FIG. 5 illustrates a method 500 for a multi-SIM mobile device (e.g., the multi-SIM mobile device 102 in FIG. 1) to determine an order for channel scanning for various radio access technologies supported by the multi-SIM mobile device by modifying the priority of RATs based on identified partial out-of-service conditions. The method 500 is similar to the method 300, except that the method 500 includes more detailed operations that may be performed by the multi-SIM mobile device as an operational loop. For example, the method 500 may be a system routine, thread, or application continually performed by a processor of the multi-SIM mobile device to use modified priorities when reordering RATs for scanning operations. As described above, the multi-SIM mobile device may be a device supporting more than one RAT that utilizes shared resources, such as an RF chain. For example, the multi-SIM mobile device may be a DSDS device with at least two SIM modules with different corresponding RATs (e.g., 1x CDMA, GSM, etc.) that are each configured to use the same RF chain and antenna for communicating with their respective cellular networks.

In block 502, the processor of the multi-SIM mobile device may store a default priority (or priority value) for each RAT in a plurality of RATs configured to utilize shared resources of the multi-SIM mobile device. As described in this disclosure (e.g., with reference to FIG. 4), the default priorities may be labels, numbers, codes other information indicating the importance, rank, or order that each of the RATs have by default. In block 504, the processor of the multi-SIM mobile device may determine an order for scanning for service for each RAT in the plurality of RATs using the default priorities. For example, the multi-SIM mobile device may generate an ordered list of the various RATs that may be used for managing the shared resources for scanning for services.

In block 506, the processor of the multi-SIM mobile device may perform scanning operations (i.e., conduct RAT channel scanning operations) to acquire service for each RAT in the plurality of RATs based on the determined order. The time required for performing the scanning operations for each RAT may differ depending on various factors, such as the number of channels available for scanning, the signal strength of channels, etc. The identified conditions may include descriptions or indicators of signal strengths, available services, and/or scanning success for each RAT.

In block 508, the processor of the multi-SIM mobile device monitors the channel conditions of each RAT in the plurality of RATs, and stores a value or indication of whether each RAT is in service with good channel conditions (i.e., store the channel conditions). In some embodiments, the processor may also store an indication of when the RAT is out of service. In some embodiments, the processor may simply store a single bit of information indicating whether the RAT is currently in service or out of service (e.g., a “1” when in service and a “0” when out of service). These channel conditions (or an in service/out of service state value) may be stored in data tables in which each of the RATs is associated with a data record within the data tables, or alternatively in bits or flags associated with each RAT. For example, the multi-SIM mobile device may set a system variable to a value indicating “full,” “limited,” or “no” service for an individual RAT.

In determination block 510, the processor of the multi-SIM mobile device may determine when one of the plurality of RATs begins using the shared resources. In other words, the processor may determine when a switchover event has occurred or is about to occur. For example, the multi-SIM mobile device may determine when the first RAT has requested an RF chain for conducting a voice call. While the processor determines that no RAT has begun using the shared resources (i.e., determination block 510=“No”), the multi-SIM mobile device may continue to periodically monitor and store channel conditions of each RAT in block 504 so that the store channel conditions remain current.

When the processor of the multi-SIM mobile device determines that a RAT has requested or began to use the shared resources (i.e., determination block 510=“Yes”), the processor may optionally reset stored data indicating whether each RAT was in a “partial OOS” condition in optional block 511. Such stored data may be initially set to indicate that no RAT in the plurality is in a partial out-of-service condition. For example, the multi-SIM mobile device may zero-out or otherwise re-initialize system variables, bits, flags, or data fields corresponding to the partial out-of-service conditions for each RAT in the plurality. In some embodiments, the multi-SIM mobile device may also reset values in a data table (or other data structure) established to indicate the current priorities of the various RATs. For example, the multi-SIM mobile device may set all current priority values for the RATs to be their respective default priority values. This reset may be important in iterations of the operational loop of the method 500 that occur subsequent to using modified priorities as described below. The operation of resetting the channel condition data table in optional block 511 is optional because the data may be cleared at any time, such as at the completion of all channel scanning operations in block 520 described below.

In block 512, the processor of the multi-SIM mobile device may identify the RATs that were “in-service” at the certain time when the first RAT obtained the shared resources. The processor may make this identification by evaluating the most recent stored identified channel conditions for each RAT in the plurality. For example, the processor may evaluate a stored list of recent channel conditions to identify any RATs that had connectivity, strong signal strength, or “full service” with their respective cellular networks prior to a RAT beginning to use the shared resources. As the RAT using the shared resources must necessarily be in service, the processor may assume that that RAT is “in-service”.

In block 514, the processor of the multi-SIM mobile device may calculate a modified priority for each RAT identified to be “in-service” when the first RAT obtained the shared resources (i.e., when the first RAT began using the shared resources) based on the default priorities. As described above, the modified priority for a RAT may be a value that is offset from a stored default priority value such that the RAT may be afforded a higher priority, rank, or importance in subsequent scanning operations than it normally would have. For example, the modified priority value of a RAT identified as being in the partial out-of-service condition may be a value that is higher than the highest stored default priority value for all of the RATs in the plurality of RATs.

In block 515, the processor of the multi-SIM mobile device may store the calculated modified priorities for the “in-service” RATs, such as by storing the calculated modified priority values in a data table or other data structure. In some embodiments, the modified priority values may be static, and as such the multi-SIM mobile device may perform the calculations and store the modified values only one time, such as at the beginning of the method 500. However, in other embodiments, the modified priority values may be dynamic values that are calculated and stored on-the-fly. For example, the modified priority values may be calculated based off of default priority values and a location, time of day, user preferences, previously stored signal strength, and other factors that may occasionally change over time. In some embodiments, the multi-SIM mobile device may store the modified calculated priority values in a dynamic data table or other data structure that stores the “current” priorities of the various RATs.

In optional block 516, the processor of the multi-SIM mobile device may set (or store) a datum indicating the “partial OOS” condition for each RAT determined to be “in-service” when the first RAT obtained the shared resources. The multi-SIM mobile device may update or otherwise modify the data described above with reference to the operations of optional block 511 (i.e., the data set in optional block 516 may be the same data reset by the processor in optional block 511). For example, the data set to indicate a RAT is in a partial OOS condition may be a system variable, bit, or flag.

In block 518, the processor of the multi-SIM mobile device may wait until the shared resources are freed by the RAT that is using them. For example, the processor may monitor use of the shared resources to identify when an ongoing call ends. As another example, the multi-SIM mobile device may determine that the resources are freed upon detecting that the signal strength for the RAT using the shared resources has gone below a threshold (e.g., a dropped call) and/or upon detecting a user input, such as the press of an “end call” button.

When the processor of the multi-SIM mobile device determines that the shared resources have been freed, in block 520 the processor may determine an order for conducting channel scanning to allow each RAT to reacquire service using the modified priorities of the RATs having set data indicating the partial OOS condition and the default priorities for other RATs in the plurality of RATs (i.e., the RATs not in the partial OOS condition). In this operation, the multi-SIM mobile device may perform look-up operations for each RAT to identify the appropriate priority value and sort the RATs into an ordered list. For example, the multi-SIM mobile device may query and otherwise evaluate bits, flags, and other data stored in association with the RATs to identify those RATs that were in a partial OOS condition at the time the first RAT obtained the shared resources to identify those RATs that may be ordered using their respective modified priority values. In some embodiments, the multi-SIM mobile device may utilize a dynamic data table that stores the current priorities of each RAT in the plurality, which may include modified and/or default priority values that have been copied to the data table from static data tables for the default and modified priorities.

In block 506, the processor of the multi-SIM mobile device may begin performing scanning operations for each RAT in the order determined in block 520. The multi-SIM mobile device may be configured to perform scanning operations with this order only immediately after the shared resources are freed. In other words, the modified priority values may be used only one time to change the order in which RATs are scanned. In some embodiments, the RAT channel scanning order determined based on both modified and default priority values may be used by the multi-SIM mobile device for a predetermined number of subsequent scans or alternatively for a predetermined period of time.

In some embodiments, rather than increasing the priority associated with each RAT determined to be in service prior to a switchover event, the processor may instead decrease the priority associated with each RAT determined to be out of service prior to the switchover event.

In some embodiments, the processor may simply calculate a modified priority for each RAT, not just those that were in service prior to the switchover event. In such embodiments, the processor need not perform the operations in blocks 511, 512, and 516, and in block 514 the processor may calculate priorities for each RAT and store all of the calculated priorities in block 515, with those RATs that are actually out of service having a modified priority that may be equal to the default priority. In such embodiments, the operations in block 520 four determining the order for RAT channel scanning may be based upon the calculated or modified priorities for all of the RATs.

In some embodiments, the processor may calculate the modified priorities after detecting that the shared resources have been freed (e.g., when an ongoing call ends), in which case the calculated priorities need not be stored (i.e., the operations of block 515 may not be performed) as they may be used immediately to determine the order for RAT channel scanning in block 520.

Various embodiments may be implemented in any of a variety of multi-SIM mobile devices, an example of which is illustrated in FIG. 6. For example, a tablet multi-SIM mobile device 600 may include a processor 601 coupled to internal memory 602. The internal memory 602 may be volatile or non-volatile memory, and may also be secure and/or encrypted memory, or unsecure and/or unencrypted memory, or any combination thereof. The processor 601 may also be coupled to a touch screen display 610, such as a resistive-sensing touch screen, capacitive-sensing touch screen infrared sensing touch screen, etc. The tablet multi-SIM mobile device 600 may have one or more radio signal transceivers 604 (e.g., Peanut, Bluetooth, Zigbee, WiFi, RF radio) and antennas 608 for sending and receiving wireless signals as described herein. The transceivers 604 and antennas 608 may be used with the above-mentioned circuitry to implement the various wireless transmission protocol stacks and interfaces. The tablet multi-SIM mobile device 600 may include a cellular network wireless modem chip 620 that enables communication via cellular network(s). The tablet multi-SIM mobile device 600 may also include a physical button 606 for receiving user inputs. The tablet multi-SIM mobile device 600 may also include various sensors coupled to the processor 601, such as a camera 622, a microphone 623, and an accelerometer 624. The tablet multi-SIM mobile device 600 also include various SIM modules (or SIM cards) coupled to the processor 601 and associated with various subscriptions supported by the tablet multi-SIM mobile device 600, such as a first SIM module 650 and a second SIM module 652.

FIG. 7 illustrates a multi-core multi-SIM mobile device 700 suitable for use with various embodiments. In various embodiments, the multi-SIM mobile device 700 may include a processor 701 coupled to a touchscreen controller 704 and an internal memory 702. The processor 701 may be one or more multicore ICs designated for general or specific processing tasks. The internal memory 702 may be volatile or non-volatile memory, and may also be secure and/or encrypted memory, or unsecure and/or unencrypted memory, or any combination thereof. The touchscreen controller 704 and the processor 701 may also be coupled to a touchscreen panel 712, such as a resistive-sensing touchscreen, capacitive-sensing touchscreen, infrared sensing touchscreen, etc. The multi-SIM mobile device 700 may have one or more radio signal transceivers 708 (e.g., Peanut®, Bluetooth®, Zigbee®, Wi-Fi, RF radio) and antennae 715, for sending and receiving, coupled to each other and/or to the processor 701. The transceivers 708 and antennae 715 may be used with the above-mentioned circuitry to implement the various wireless transmission protocol stacks and interfaces. The multi-SIM mobile device 700 may include a cellular network wireless modem chip 716 that enables communication via cellular network(s) and is coupled to the processor. The multi-SIM mobile device 700 may include a peripheral device connection interface 718 coupled to the processor 701. The peripheral device connection interface 718 may be singularly configured to accept one type of connection, or multiply configured to accept various types of physical and communication connections, common or proprietary, such as USB, FireWire, Thunderbolt, or PCIe. The peripheral device connection interface 718 may also be coupled to a similarly configured peripheral device connection port (not shown). The multi-SIM mobile device 700 may also include speakers 714 for providing audio outputs. The multi-SIM mobile device 700 may also include a housing 720, constructed of a plastic, metal, or a combination of materials, for containing all or some of the components discussed herein. The multi-SIM mobile device 700 may include a power source 722 coupled to the processor 701, such as a disposable or rechargeable battery. The rechargeable battery may also be coupled to the peripheral device connection port to receive a charging current from a source external to the multi-SIM mobile device 700. The multi-SIM mobile device 700 may also include various SIM modules (or SIM cards) coupled to the processor 701 and associated with various subscriptions supported by the multi-SIM mobile device 700, such as a first SIM module 710 and a second SIM module 712.

The processors 601 and 701 may be any programmable microprocessor, microcomputer or multiple processor chip or chips that can be configured by software instructions (applications) to perform a variety of functions, including the functions of various embodiments described above. In the various devices, multiple processors may be provided, such as one processor dedicated to wireless communication functions and one processor dedicated to running other applications. Typically, software applications may be stored in the internal memory 602 and 702 before they are accessed and loaded into the processors 601 and 701. The processors 601 and 701 may include internal memory sufficient to store the application software instructions. In many devices the internal memory may be a volatile or nonvolatile memory, such as flash memory, or a mixture of both. For the purposes of this description, a general reference to memory refers to memory accessible by the processors 601 and 701 including internal memory or removable memory plugged into the various devices and memory within the processors 601 and 701.

The foregoing method descriptions and the process flow diagrams are provided merely as illustrative examples and are not intended to require or imply that the steps of various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of processors, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The steps of a method or algorithm disclosed herein may be embodied in a processor-executable software module or processor-executable software instructions which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for a multi-SIM mobile device supporting a plurality of radio access technologies (RATs), comprising:
modifying priorities for each of the plurality of RATs that is determined to have been in good channel conditions prior to one of the plurality of RATs beginning to use a shared resource of the multi-SIM mobile device; and
determining based on the modified priorities an order in which the plurality of RATs will perform channel scanning to reacquire service when the shared resource becomes available.

2. The method of claim 1, wherein modifying priorities for each of the plurality of RATs that is determined to have been in good channel conditions prior to one of the plurality of RATs beginning to use a shared resource of the multi-SIM mobile device comprises:
determining when a first radio access technology (RAT) within the plurality of RATs begins using the shared resource of the multi-SIM mobile device that is configured to be shared by the plurality of RATs;
determining whether a second RAT within the plurality of RATs was in-service or out of service when the first RAT began using the shared resource; and
calculating a modified priority value for the second RAT in response to determining that the second RAT was in-service when the first RAT began using the shared resource.

3. The method of claim 1, wherein determining based on the modified priorities an order in which the plurality of RATs will perform channel scanning to reacquire service when the shared resource becomes available comprises:
determining the order in which the plurality of RATs will perform channel scanning to reacquire service based on default priority values for those RATs determined to have been out of service when the first RAT began using the
modify priorities for each of a plurality of radio access technologies (RATs) of the multi-SIM mobile device that is determined to have been in good channel conditions prior to one of the plurality of RATs beginning to use a shared resource of the multi-SIM mobile device; and
determine based on the modified priorities an order in which the plurality of RATs will perform channel scanning to reacquire service when the shared resource becomes available.

10. The multi-SIM mobile device of claim 9, wherein the processor is further configured to:
determine when a first radio access technology (RAT) within the plurality of RATs begins using the shared resource of the multi-SIM mobile device that is configured to be shared by the plurality of RATs;
determine whether a second RAT within the plurality of RATs was in-service or out of service when the first RAT began using the shared resource; and
calculate a modified priority value for the second RAT in response to determining that the second RAT was in-service when the first RAT began using the shared resource.

11. The multi-SIM mobile device of claim 9, wherein the processor is further configured to:
determine the order in which the plurality of RATs will perform channel scanning to reacquire service based on default priority values for those RATs determined to have been out of service when the first RAT began using the shared resource and based on the modified priorities for those RATs determined to have been in-service when the first RAT began using the shared resource.

12. The multi-SIM mobile device of claim 9, wherein the processor is further configured to perform RAT channel scanning to reacquire service on the plurality of RATs in the determined order when the shared resource becomes available.

13. The multi-SIM mobile device of claim 9, wherein the processor is further configured to store data to identify those of the plurality of RATs determined to have been in good channel conditions prior to one of the plurality of RATs beginning to use the shared resource as being in a partial out-of-service condition.

14. The multi-SIM mobile device of claim 9, wherein the processor is further configured to:
store channel conditions related to each in the plurality of RATs; and
determine whether each of the plurality of RATs was in good channel conditions prior to one of the plurality of RATs beginning to use the shared resource of the multi-SIM mobile device based on the stored channel conditions.

15. The multi-SIM mobile device of claim 9, wherein the shared resource is a radio frequency (RF) chain and the multi-SIM mobile device is one of a dual-subscription, dual-standby (DSDS) mobile device or a dual-subscription, dual-active (DSDA) mobile device.

16. The multi-SIM mobile device of claim 9, wherein the processor is further configured to modify the priorities to be values that are higher than a highest stored default priority.

17. A multi-SIM mobile device, comprising:
means for modifying priorities for each of a plurality of radio access technologies (RATs) of the multi-SIM mobile device that is determined to have been in good channel conditions prior to one of the plurality of RATs beginning to use a shared resource of the multi-SIM mobile device; and
means for determining based on the modified priorities an order in which the plurality of RATs will perform channel scanning to reacquire service when the shared resource becomes available.

18. A non-transitory processor-readable storage medium having stored thereon processor-executable instructions configured to cause a processor to perform operations for a multi-SIM mobile device supporting a plurality of radio access technologies (RATs), the operations comprising:
modifying priorities for each of the plurality of RATs of the multi-SIM mobile device that is determined to have been in good channel conditions prior to one of the plurality of RATs beginning to use a shared resource of the multi-SIM mobile device; and
determining based on the modified priorities an order in which the plurality of RATs will perform channel scanning to reacquire service when the shared resource becomes available.

19. The non-transitory processor-readable storage medium of claim 18, wherein the stored processor-executable instructions are configured to cause the processor to perform operations such that modifying priorities for each of the plurality of RATs of the multi-SIM mobile device that is determined to have been in good channel conditions prior to one of the plurality of RATs beginning to use a shared resource of the multi-SIM mobile device, the operations comprising:
determining when a first radio access technology (RAT) within the plurality of RATs begins using the shared resource of the multi-SIM mobile device that is configured to be shared by the plurality of RATs;
determining whether a second RAT within the plurality of RATs was in-service or out of service when the first RAT began using the shared resource; and
calculating a modified priority value for the second RAT in response to determining that the second RAT was in-service when the first RAT began using the shared resource.

20. The non-transitory processor-readable storage medium of claim 18, wherein the stored processor-executable instructions are configured to cause the processor to perform operations such that determining based on the modified priorities an order in which the plurality of RATs will perform channel scanning to reacquire service when the shared resource becomes available, the operations comprising:
determining the order in which the plurality of RATs will perform channel scanning to reacquire service based on default priority values for those RATs determined to have been out of service when the first RAT began using the shared resource and based on the modified priorities for those RATs determined to have been in-service when the first RAT began using the shared resource.

21. The non-transitory processor-readable storage medium of claim 18, wherein the stored processor-executable instructions are configured to cause the processor to perform operations further comprising performing RAT channel scanning to reacquire service on the plurality of RATs in the determined order when the shared resource becomes available.

22. The non-transitory processor-readable storage medium of claim 18, wherein the stored processor-executable instructions are configured to cause the processor to perform operations further comprising storing data to identify those of the plurality of RATs determined to have been in good channel conditions prior to one of the plurality of RATs beginning to use the shared resource as being in a partial out-of-service condition.

23. The non-transitory processor-readable storage medium of claim 18, wherein the stored processor-executable instructions are configured to cause the processor to perform operations further comprising:
storing channel conditions related to each in the plurality of RATs; and
determining whether each of the plurality of RATs was in good channel conditions prior to one of the plurality of RATs beginning to use the shared resource of the multi-SIM mobile device based on the stored channel conditions.

24. The non-transitory processor-readable storage medium of claim 18, wherein the shared resource is a radio frequency (RF) chain and the multi-SIM mobile device is one of a dual-subscription, dual-standby (DSDS) mobile device or a dual-subscription, dual-active (DSDA) mobile device.

25. The non-transitory processor-readable storage medium of claim 18, wherein the stored processor-executable instructions are configured to cause the processor to perform operations such that modifying priorities for each of the plurality of RATs that is determined to have been in good channel conditions prior to one of the plurality of RATs beginning to use a shared resource of the multi-SIM mobile device comprises modifying the priorities to be values that are higher than a highest stored default priority.
